(19) United States
(12) Patent Application Publication
(10) Pub. No.: US 2006/0153494 A1
(43) Pub. Date: Jul. 13, 2006

(54) Optical switch for routing multiple optical signals

(75) Inventors: Donald A. Kenagy, Atlanta, GA (US); Roy Guynn, Blacksburg, VA (US); Reddy Urimindi, Plano, TX (US); John Carberry, Talbott, TN (US)

Correspondence Address: PITTS AND BRITTIAN P C, P O BOX 51295, KNOXVILLE, TN, 37950-1295, US

(73) Assignee: Neptec Optical Solutions, Inc., Jefferson City, TN (US)

(21) Appl. No.: 11/033,948

(22) Filed: Jan. 12, 2005

(51) Int. Cl. G02B 6/26

(52) U.S. Cl. 385/18

(57) ABSTRACT

An apparatus for routing a plurality of optical input signals to a plurality of optical output connections. In one embodiment, a switch includes an optical bench receiving and securing a plurality of input collimators and output collimators. The optical bench also receives and secures a plurality of actuators arranged in an array for reflecting and redirecting the optical signal from the input collimators to the output collimators.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to an optical switch, that is, a switch for optical signals, such as those carried by fiber optic cables. More particularly, this invention pertains to an optical switch that routes a plurality of optical input signals to a plurality of optical output connections.

2. Description of the Related Art

Optical signals, like their electrical signal counterparts, travel paths that need to be directed to specific locations and those locations are susceptible to change. Electrical signals pass through switches, or routers, that direct any one of a multitude of inputs to any one of a multitude of outputs. Such electrical switches vary in complexity to simple mechanical switches that make and break electrical connections to more complex electrical switches that use circuitry to route the electrical signals.

Optical switching, or routing, initially was performed by plugging in selected fiber optic cables to selected connectors, thereby forming an optical connection. Various switches have been developed to solve the problem of automating optical switching, or routing.

For example, U.S. Pat. No. 6,522,800, titled “Microstructure switches,” issued to Lucero on Feb. 18, 2003, discloses one embodiment of micro-machined devices of silicon (MEMS). Lucero discloses “a microstructure switch having a main body, a moveable switching element, one or more membranes which connect the moveable switching element to the main body and an actuator which moves the moveable switching element from a first position to a second position. The membranes may be either or both of a primary membrane or a secondary membrane. A primary membrane may be used as a temporary membrane which serves to position the moveable switching element until it is permanently positioned by a secondary membrane, or by an actuator. At this point the temporary membrane is removed.”

U.S. Pat. No. 6,571,030, titled “Optical cross-connect switching system,” issued to Ramaswami, et al., on May 27, 2003, discloses an optical cross-connect switching system that includes micro-machined mirrors and a servo system for directing optical signals to the mirrors. Ramaswami discloses a switch subsystem 110 that includes optical switch matrices 241 and 242 that include multiple arrays 300 of micro-machined mirrors that have a mirrored surface 311 and torsional flexures 320, 330 that enable the mirror 310 to adjust its physical orientation to reflect incoming light signals in any selected direction.

U.S. Pat. No. 5,726,788, titled “Dynamically reconfigurable optical interface device using an optically switched backplane,” issued to Fee, et al., on Mar. 10, 1998, discloses an optical interface device using 1×2 optical switches as a basic building block to build N×M switches. A 1×2 optical switch is a switch having a single optical input that is switched between two optical outputs, and Fee does not disclose any structural details of such a switch. Fee discloses a construction of a 1×4 switch and a 4×4 switch using a plurality of 1×2 switches.

United States Patent Application Number 2003/0231837, titled “Electromagnetic linear optical positioner,” published on Dec. 18, 2003, discloses a switch actuator 20 that linearly moves a mirror or other optical element. This published application discloses using a plurality of actuators 20 in a switch module 21; however, the application does not disclose any structural configuration of such a switch module 21 other than that actuator mirror is selectively positioned in the optical light path. The published application does not disclose or solve the problems related to securing and aligning the actuators 20, collimators, and other elements necessary to construct such a switch module 21. Nor does the published application address issues relating to temperature variations over an operating range.

One consideration in constructing and using optical switches, or routers, is the bending radius of the fiber optic cable. Fiber optic cables have a minimum bend radius, which is large relative to the cable diameter. Accordingly, routing of fiber optic cables oftentimes determines the size and layout of fiber optic equipment, which is commonly rack mounted with input and output connections accessible from a front panel. In order to accommodate high density requirements, it is desirable to minimize the size of fiber optic equipment.

It is also desirable to minimize attenuation of the optical signals in optical equipment. A factor that affects attenuation is the dimensional stability of the components in the optical equipment. The optical signal from an fiber optic cable has a small size and small changes in alignment, for example, due to changes in temperature, may cause attenuation of the optical signal. Further, it is desirable to operate optical equipment over a wide temperature range, which is at odds with the desire to minimize attenuation.

### BRIEF SUMMARY OF THE INVENTION

According to one embodiment of the present invention, an optical switch is provided. The optical switch includes actuators that route a plurality of optical signals to a plurality of optical outputs. The actuators are arranged in an array of rows and columns with the input collimators and the output collimators aligned with the rows and columns of the array.

Another embodiment provides for a plurality of failsafe collimators located opposite the input collimators. For the situation where an actuator fails to move to the extended position, the input collimator is in optical communication with the associated failsafe collimator, thereby providing information of the actuator failure.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a 4×4 switch without the cover;

FIG. 2 is an exploded view of one embodiment of the 4×4 switch;

FIG. 3 is a side view of one embodiment of the 4×4 switch without the cover;

FIG. 4 is a top view of one embodiment of the 4×4 switch without the cover;

FIG. 5 is a perspective view of one embodiment of a switch body;

FIG. 6 is a perspective view of one embodiment of a circuit board and cable assembly;

FIG. 7 is a top view of one embodiment of a 4×4 switch with a failsafe option.

### DETAILED DESCRIPTION OF THE INVENTION

An apparatus for routing a plurality of optical signals to a bank of outputs is disclosed. The optical switch 100, in the illustrated embodiment, has four optical inputs and four optical outputs, and the switch 100 allows each of the four inputs to be routed to any of the four outputs. As used herein, a switch is a single, integrated device that selectively makes optical connections between one or more inputs and one or more outputs and is not divisible into smaller switches with a lesser number of inputs and outputs. Also, as used herein, a switch array is a collection of switches, and the switch array selectively makes optical connections between a plurality of inputs and a plurality of outputs.

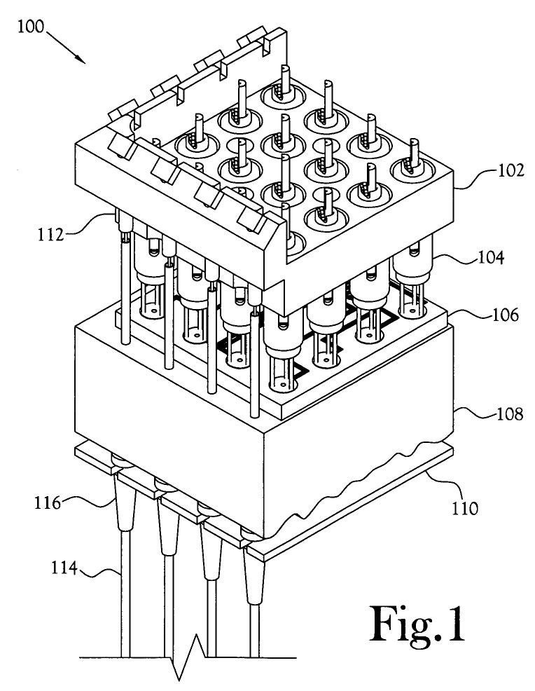

FIG. 1 illustrates a perspective view of one embodiment of a 4×4 switch 100 without the cover 202 in place. The illustrated embodiment of the 4×4 switch 100 includes a switch body, or optical bench, 102 with sixteen switch actuators 104 arranged in an array. The actuators 104 are electrically connected to a circuit board 106, which is positioned above a block of hydrophobic gel 108. Below the gel block 106 is the bottom cover plate 110. Extending through the bottom cover plate 110, the gel block 103, and into the switch body 102 are the collimators 112 with attached fiber optic pigtails 114. It is apparent in FIGS. 1, 2, and 3 that the fiber optic pigtails 114 connected to the collimators 112 are parallel and adjacent. The illustrated arrangement of the fiber optic pigtails 114 permits the pigtails 114 to be routed to an interface panel containing optical input and output connections, and such routing requires minimal bending of the pigtails 114 and any other optical cables.

The collimators 112 are in two groups: one for receiving optical input signals and another for transmitting optical output signals. The actuators 104 have mirrors that reflect and redirect the optical input signals to the collimators 112 that transmit the optical output signals. The actuators 104 are selectively operated to route the optical output signals to selected output collimators 112.

The illustrated embodiment of the switch 100 has four input collimators 112 and four output collimators 112. Those skilled in the art will recognize that the number of input collimators 112 and output collimators 112, along with the number of actuators 104, can vary without departing from the spirit and scope of the present invention.

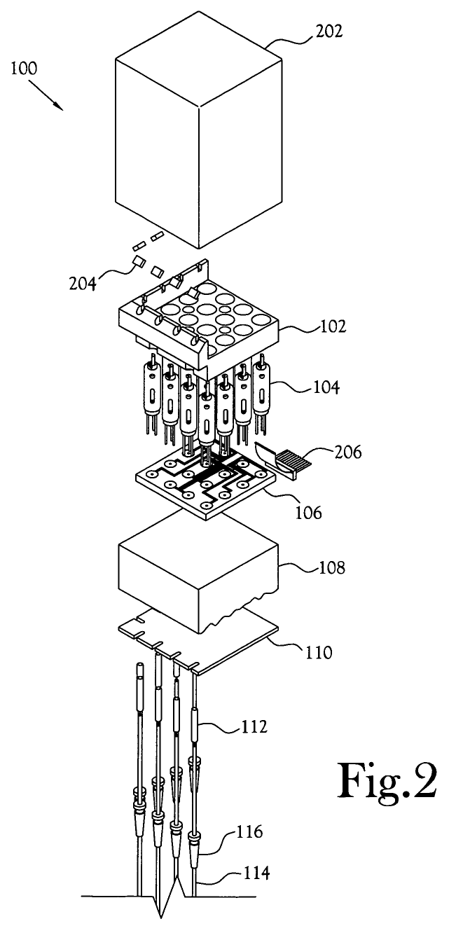

FIG. 2 illustrates an exploded view of the embodiment of the 4×4 switch 100 shown in FIG. 1. FIG. 2 shows the cover 202 that is placed over the components. The cover 202 protects the switch 100 from contamination and also prevents external light sources from interfering with the optical signals passing through free space. The cover 202 is secured to the bottom cover plate 110 to encapsulate the switch internals.

The hydrophobic gel block 108, in one embodiment, is positioned adjacent the bottom cover plate 110. In one embodiment, the gel block 108 seals the opening of the cover 202. The gel block 108 serves to repel water and moisture from entering into the volume bounded by the cover 202 and which contains the portion of the switch 100 in which the optical signal travels in free space.

The switch body 102 is adapted to receive and secure the array of actuators 104. The actuators 104 have a movable mirror 404 that, in the extended position, intercepts and redirects an optical signal, and in the retracted position, allows the optical signal to pass unimpeded. The opposite end of each actuator 108 includes the electrical leads for controlling the operation of the actuator 108. Examples of actuators 104 are illustrated in U.S. Pat. No. 6,606,429, titled “Electromechanically Controlled Optical Element,” and U.S. Pat. No. 6,735,006, titled “Optical switch assembly.” In one embodiment, the actuators 104 are latching actuators, that is, electrical power is applied to energize the actuator and move the actuator mirror 404 to either the extended or retracted position. After electrical power is removed, the actuator mirror 404 is latched in the position to which it was moved.

The electrical leads extending from the actuator 104 are connected to the circuit board 106. A cable assembly 206 connects to the circuit board 106 and provides electrical connection between the switch 100 and external devices. In one embodiment, the cable assembly 206 passes through an opening in the cover 202.

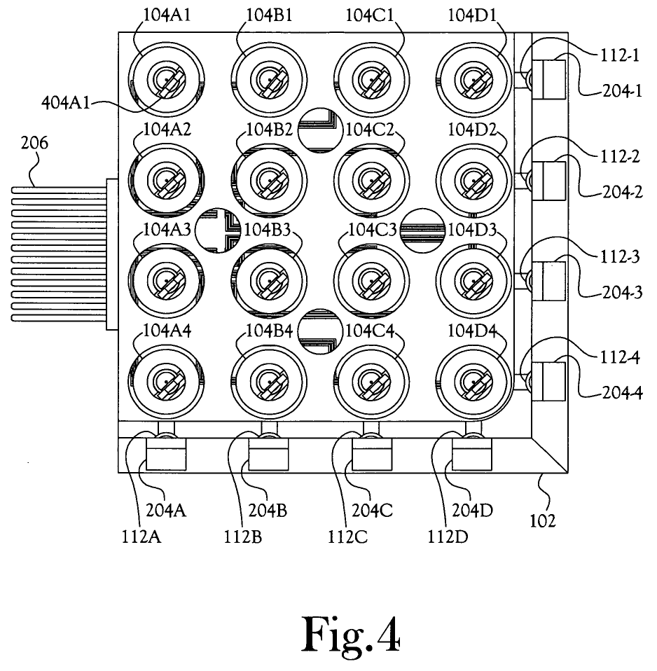

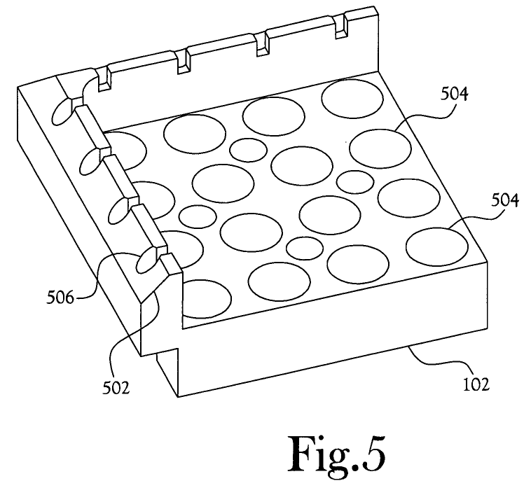

The switch body 102 is also adapted to receive and secure the collimators 112. The switch body 102 has a surface 502 canted at 45 degrees to which front surface mirrors 204 are secured. FIG. 4 illustrates the configuration of the mirrors 204 and the actuators 104. FIG. 5 illustrates the configuration of one embodiment of the switch body 102.

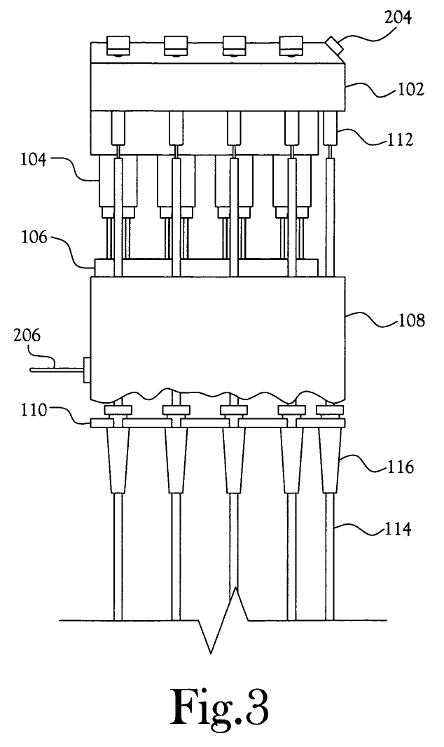

FIG. 3 illustrates a side view of one embodiment of a 4×4 switch 100 without the cover 202 in place. The collimators 112 are secured to the switch body 102 and the fiber optic pigtails 114 extend through the gel block 108 and the bottom cover plate 110. Each fiber optic pigtails 114 has a resilient strain relief 116 to protect the pigtail 114 where it passes through the bottom cover plate 110. The cable assembly 206 extends from the circuit board 106 and runs alongside the gel block 108.

FIG. 4 illustrates a top view of one embodiment of the 4×4 switch 100 without the cover 202 in place. FIG. 5 illustrates a perspective view of one embodiment of a switch body 102. The collimators 112 are received and secured along two sides of the switch body 102 in openings 506 spaced along the canted surface 502 of the switch body 102. The mirrors 204 are secured over the openings 506 and reflect an optical light beam between the associated collimator 112 and an actuator mirror 404. The actuators 104 are arranged in a rectilinear array, with the rows and columns in line with the optical signals emitted by the associated collimators 112 and reflected by the associated mirrors 104 such that the actuator mirrors 404 reflect the optical signal with the actuator mirror 404 is in the extended position.

The illustrated 4×4 switch 100 operates by a light beam being emitted from a collimator 112A, reflected from its associated mirror 204A, reflected from one of the four mirrors 404 moved into the extended position by one of the actuators 104A1, 104A2, 104A3, 104A4, reflected from the correspond mirror 204-1, 204-2, 204-3, 204-4, and into the associated collimator 112. Accordingly, the optical signal carried by an optical light beam emitted from the collimator 112A is directed to any one of the four output collimators 112-1, 112-2, 112-3, 112-4. The same is true of the other three input collimators 112B, 112C, 112D. The 4×4 array configuration of the actuators 104 allows all four of the input collimators 112A, 112B, 112C, 112D to be routed, in any permutation, to the four output collimators 112-1, 112-2, 112-3, 112-4. For a 4×4 switch 100, there are a total of 24 different permutations, that is, there are 24 different ways the input signals can be routed to the output.

For example, to route the optical signal from input collimator 112B to output collimator 112-3, the actuators 104B4, 104C3, 104C4 in the optical path are operated to the retracted position and actuator 104B3 is operated to the extended position. The position of the other actuators 104A1, 104A2 along the line of the reflected optical signal from input collimator 112A does not affect the routing of the signal from the collimator 112A; however, if any of their mirrors 404 are in the extended position, the light path from the other collimator 112A may be affected. In one embodiment, the mirror 404A1 is left in the extended position, and in another embodiment, the actuator 104A1 is replaced with a device with a mirror 404A1 positioned in the extended position, because this mirror 404A1 cannot interfere with any other light path.

FIG. 5 illustrates the optical body, or bench, 102 with the openings 504 in which the actuators 104 are received and secured. The openings 504 are positioned in a 4×4 array. The actuators 104, in one embodiment, are secured in the openings 504 by an adhesive disposed between the body of the actuator 104 and the switch body 102. Before the adhesive is cured, the actuator 104 is aligned. In a similar manner, the collimators 112 are secured in the openings 502 by an adhesive disposed between the body of the collimator 112 and the switch body 102. Before the adhesive is cured, the collimator 112 is aligned. The canted surface 502 is precisely machined to a 45 degree angle, thereby allowing the mirrors 204 to accurately reflect the optical signals between the collimators 112 and the actuators 104.

The optical bench 102 is in the general shape of a table with two side-walls extending above the upper surface of the table. That is, the bench 102 has a base with two perpendicular side-walls. Spaced along the sides of the bench 102 walls are openings into which the collimators 112 fit with clearance for an adhesive. Spaced along the top of the bench 102 walls are slots 506 that pass through the chamfer, or canted surface, 502 and intersect with the openings for the collimators 112. The optical paths travel between the collimators 112 and actuators 104 by passing through the slots 506. Those skilled in the art will recognize that the slots can be rectangular as illustrated or of any other shape, such as a V-shaped groove or even a drilled opening, without departing from the spirit and scope of the present invention. The illustrated configuration of the optical bench 102 provides for a short free space distance for the optical signal to travel, which, for fiber optics, minimizes signal degradation.

The two side-walls of the optical bench 102 have chamfers 502 between their side surfaces and top surfaces. In the illustrated embodiment, each chamfer 502 is at a precise 45° angle. Mirrors 204 are reflectors attached to the surfaces 502 with a reflective surface positioned to reflect the optical signal from or to the associated collimator 112. In one embodiment, the mirrors 204 are front-sided mirrors having a reflective surface on the surface of the mirror 204 facing the optical bench 102 surfaces 502. The mirrors 204 in one embodiment are glass with a reflective surface. In another embodiment, the mirrors 204 are metal, such as Kovar, with a reflective surface. In one embodiment an adhesive (not illustrated) is used to affix the mirrors 204 to the optical bench 102.

In one embodiment the bench 102 is made of Kovar metal, which has a coefficient of thermal expansion similar to that of glass. The mirrors 204 are fixed to the bench 102 with an adhesive. In one embodiment the adhesive has a coefficient of thermal expansion similar to that of the mirrors 204 and the bench 102. Likewise, the actuators 104 and collimators 112 are fabricated of materials with a coefficient of thermal expansion similar to that of the bench 102. In one embodiment the mirrors 204 are glass plates with a front side reflective coating responsive to the frequencies passed by the collimators 112. In another embodiment, the mirrors are flat plates with a front side reflective coating, and the plates have a coefficient of thermal expansion similar to that of the optical bench 102.

The precise alignment of the collimators 212 to the mirrors 204 is critical in fiber optics. Any misalignment can result in an attenuation of the signal or the loss of the signal. By matching the coefficient of thermal expansion of the individual components and adhesives, the components of the switch assembly 100 remain in alignment over a wide temperature range such that the optical path does not suffer degradation as the temperature varies. In one embodiment, the temperature range is from −40° to +85° Centigrade. In another embodiment, the transition point of the adhesive is outside the operating temperature range, which enhances the dimensional stability of the switch assembly 100. In one embodiment, keeping the transition point outside the operating range is accomplished by using fillers. In still another embodiment, the adhesive has limited shrinkage, which can be accomplished with a filler. Further, the adhesive can be cured in place, which aids in the active alignment of the collimators 212 and actuators 104.

The collimators 212 and the actuators 104 are secured to the bench 102 by an adhesive. The adhesive fills a gap between the collimators 212 and the optical bench 102. The adhesive fills a gap between the actuators 104 and the optical bench 102. The gaps filled by the adhesive permit the collimators 212 and the actuators 104 to be moved relative to the bench 102 during positioning and alignment before the adhesive is cured.

In one embodiment the adhesive is a quick curing adhesive blended with amorphous silica spheres of a selected diameter. The adhesive is compressed between the mirrors 204 and the optical bench 102, with the spheres forming a monolayer, which results in dimensional stability when the adhesive is cured. In another embodiment the adhesive is Dymax OP66LS, which has a coefficient of thermal expansion similar to that of the bench 102 such that the collimators 212 remain in alignment as the temperature varies within the operating range of the switch assembly 100.

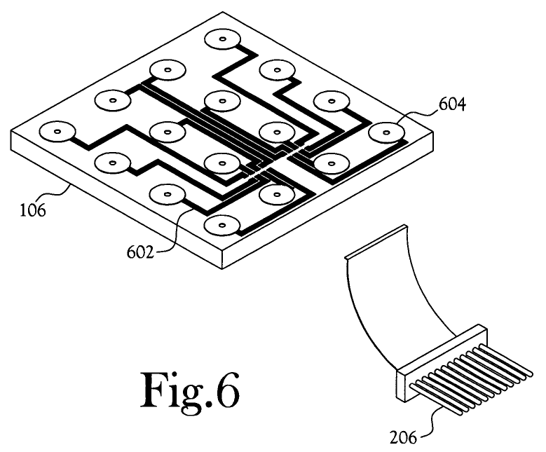

FIG. 6 illustrates a perspective view of one embodiment of a circuit board 106 and cable assembly 206. In one embodiment, the circuit board 106 includes circuit elements that receive a signal containing switch position information and apply the appropriate signals to the actuators 108 to effectuate the selected switch position. In another embodiment, the circuit board 106 includes conductive traces that provide an electrical connection between the electrical leads extending from the actuator 104.

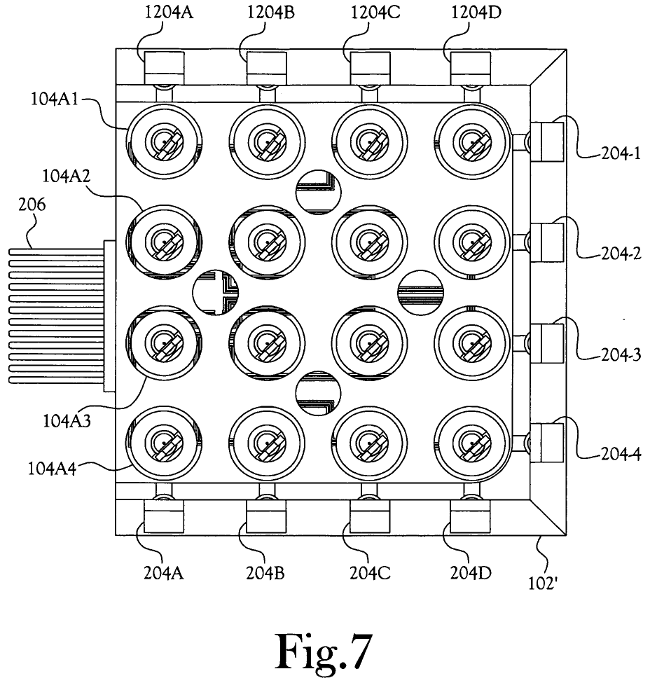

FIG. 7 illustrates a top view of one embodiment of a 4×4 switch 100′ with a failsafe option. In this embodiment, each input collimator 204A, 204B, 204C, 204D has an associated failsafe output collimator 1204A, 1204B, 1204C, 1204D positioned such that with no intervening actuator 104 in an extended position, an optical signal from an input collimator 204A, 204B, 204C, 204D passes to a failsafe output collimator 1204A, 1204B, 1204C, 1204D. The failsafe switch 100′ requires that all actuators 104 be maintained in the retracted position unless the actuator 104 is required to be in the extended position to reflect an optical signal to an output collimator 204-1, 204-2, 204-3, 204-4. A failure of an actuator 104 to reach the extended position results in the optical signal from the associated input collimator 204A, 204B, 204C, 204D to travel to the failsafe collimator 1204A, 1204B, 1204C, 1204D, where it can, in one embodiment, be otherwise routed, or in another embodiment, be detected and cause some corrective action to be taken.

In another embodiment, when a switch 100′ is to have its state changed, each actuator 104 is first moved to the retracted position, thereby causing the signal from each input collimator 204A, 204B, 204C, 204D to be sensed by the associated failsafe collimator 1204A, 1204B, 1204C, 1204D. If no signal is sensed, then the failure of an actuator 104 to retract is indicated. After all actuators 104 are retracted, the appropriate actuators 104 are then moved to the extended position. The failsafe collimator 1204A, 1204B, 1204C, 1204D are then checked to determine if any are receiving an optical signal, thereby indicating that an actuator 104 has failed to move to the extended position.

The apparatus includes various functions. For a switch 100, 100′, the function of accepting a plurality of optical inputs is implemented, in one embodiment, by the input collimators 112A-D of the switch assembly 100, 100′.

For a switch 100, 100′, the function of transmitting a plurality of optical outputs is implemented, in one embodiment, by the output collimators 112-1 to 4 of the switch assembly 100, 100′.

For a switch 100, 100′, the function of routing a plurality of optical inputs to a plurality of optical outputs is implemented, in one embodiment, by the actuators 104 of the switch assembly 100, 100′, working in conjunction with the input collimators 112A-D and the output collimators 112-1 to 4, along with the mirrors 204.

For a switch 100′, the function of detecting failure of an actuator is implemented, in one embodiment, by the failsafe collimators 1204A, 1204B, 1204C, 1204D positioned opposite the input collimators 204A, 204B, 204C, 204D.

For a switch 100, 100′, the function of holding the plurality of input collimators 112-1 to 4, the plurality of output collimators 112A-D, the plurality of actuators 104, and the plurality of mirrors 204 in fixed relation is implemented, in one embodiment, by the optical bench, or body, 102, 102′. The optical bench 102, 102′ has a base with a plurality of openings 504 that receive the actuators 104. The base also includes chamfers, or canted surfaces, 502 to which the mirrors 204 attach.

From the foregoing description, it will be recognized by those skilled in the art that an optical switch with multiple inputs and multiple outputs has been provided. The optical switch includes a plurality of input collimators, a plurality of mirrors reflecting optical signals to a plurality of actuators that selectively redirect the optical signals to a plurality of mirrors and a plurality of output collimators. With this configuration, a switch with multiple inputs and outputs is achieved without using simpler 1×2 switches as building blocks.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A switch for routing multiple optical signals, said apparatus comprising:
a plurality of input collimators each adapted to receive an optical signal;
a plurality of output collimators each adapted to transmit said optical signal, each of said plurality of output collimators substantially parallel to said plurality of input collimators;
a plurality of actuators, each of said actuators having a mirror movable between a retracted position and an extended position;
a plurality of mirrors; and
an optical bench having a base, a first side wall, and a second side wall, said optical bench having a first chamfer adjacent said first side wall and a second chamfer adjacent said second side wall, said optical bench with a plurality of actuator openings in said base for receiving said plurality of actuators in an array defined by said plurality of input collimators and said plurality of output collimators, said optical bench having a plurality of collimator openings for receiving said plurality of input collimators and said plurality of output collimators, said plurality of mirrors disposed on said first chamfer and said second chamfer such that said optical signal is reflected by each of said plurality of mirrors;
whereby said plurality of optical signals received by said plurality of input collimators are routed to selected ones of said plurality of output collimators.

2. The switch of claim 1 further including a plurality of failsafe collimators positioned in said optical bench opposite said plurality of input collimators, said plurality of failsafe collimators receiving said optical signal from a corresponding one of said plurality of input collimators when a selected one of said plurality of actuators fails to move to said extended position.

3. The switch of claim 1 further including means for detecting failure of an actuator.

4. The switch of claim 1 wherein said optical bench is mounted inside a housing.

5. The switch of claim 1 wherein said optical bench, said plurality of input collimators, said plurality of output collimators, said plurality of mirrors, and said plurality of actuators have a substantially common coefficient of thermal expansion.

6. The switch of claim 1 wherein said optical bench, said plurality of input collimators, said plurality of output collimators, said plurality of mirrors, and said plurality of actuators maintain an alignment relative to each other such that said optical signal, as received by one of said plurality of output collimators, remains at full strength over a preselected operating temperature range.

7. The switch of claim 6 wherein said operating temperature range extends down to at least −40 degrees Celsius.

8. The switch of claim 6 wherein said operating temperature range extends up to at least 85 degrees Celsius.

9. A switch for routing multiple optical signals, said apparatus comprising:
a plurality of input collimators each adapted to receive an optical signal, said plurality of input collimators defining a row;
a plurality of output collimators each adapted to transmit said optical signal, each of said plurality of output collimators substantially parallel to said plurality of input collimators, said plurality of output collimators defining a column;
a plurality of actuators, each of said actuators having a mirror movable between a retracted position and an extended position, said plurality of actuators positioned in an array defined by said row and said column; and
a plurality of mirrors, each of said plurality of mirrors positioned to reflect said optical signal between one of said input collimators and said output collimators and one of said mirrors in said extended position, said plurality of input collimators, said plurality of output collimators, said plurality of actuators, and said plurality of mirrors held in fixed relation to each other;
whereby said plurality of optical signals received by said plurality of input collimators are routed to selected ones of said plurality of output collimators.

10. The switch of claim 9 further including a means for holding said plurality of input collimators, said plurality of output collimators, said plurality of actuators, and said plurality of mirrors in fixed relation.

11. The switch of claim 9 further including an optical bench having a base, a first side wall, and a second side wall, said optical bench having a first chamfer adjacent said first side wall and a second chamfer adjacent said second side wall, said optical bench with a plurality of actuator openings in said base for receiving said plurality of actuators in an array defined by said plurality of input collimators and said plurality of output collimators, said optical bench having a plurality of collimator openings for receiving said plurality of input collimators and said plurality of output collimators, said plurality of mirrors disposed on said first chamfer and said second chamfer such that said optical signal is reflected by each of said plurality of mirrors.

12. The switch of claim 9 further including a plurality of failsafe collimators positioned opposite said plurality of input collimators, said plurality of failsafe collimators receiving said optical signal from a corresponding one of said plurality of input collimators when a selected one of said plurality of actuators fails to move to said extended position.

13. The switch of claim 9 wherein said plurality of input collimators, said plurality of output collimators, said plurality of mirrors, and said plurality of actuators have a substantially common coefficient of thermal expansion.

14. The switch of claim 9 wherein said optical bench, said plurality of input collimators, said plurality of output collimators, said plurality of mirrors, and said plurality of actuators maintain an alignment relative to each other such that said optical signal, as received by one of said plurality of output collimators, remains at full strength over a preselected operating temperature range.

15. The switch of claim 14 wherein said operating temperature range extends down to at least −40 degrees Celsius.

16. The switch of claim 14 wherein said operating temperature range extends up to at least 85 degrees Celsius.

17. A switch for routing multiple optical signals, said apparatus comprising:
a means for accepting a plurality of optical inputs;
a means for transmitting a plurality of optical outputs; and
a means for routing said plurality of optical inputs to said plurality of optical outputs.

18. The switch of claim 17 further including means for detecting failure of an actuator.
